(19) United States
(12) Patent Application Publication
(10) Pub. No.: US 2007/0093606 A1
(43) Pub. Date: Apr. 26, 2007

(54) Method for producing modified polyolefin resin

(75) Inventors: Hiroyoshi Nakajima, Ichihara-shi (JP); Katsuhisa Kitano, Ichihara-shi (JP); Makoto Satoh, Chiba-shi (JP)

Correspondence Address: BIRCH STEWART KOLASCH & BIRCH, PO BOX 747, FALLS CHURCH, VA, 22040-0747, US

(73) Assignee: Sumitomo Chemical Company, Limited, Tokyo (JP)

(21) Appl. No.: 11/583,116

(22) Filed: Oct. 19, 2006

(30) Foreign Application Priority Data
Oct. 24, 2005 (JP) 2005-308260

(51) Int. Cl. C08F 263/00

(52) U.S. Cl. 525/244

(57) ABSTRACT

A method for producing a modified polyolefin resin is disclosed which has a step of melt-kneading 100 parts by weight of polyolefin resin (A), from 0.1 to 20 parts by weight of at least two kinds of nonaromatic double-bond-containing monomer (B) and from 0.01 to 20 parts by weight of organic peroxide (C), wherein at least one member of the at least two kinds of nonaromatic double-bond-containing monomer (B) is a nonaromatic double-bond-containing monomer having at least one kind of functional group selected from the group consisting of amino group, hydroxyl group and mercapto group or a derivative of the monomer (B1), and other at least one member is a nonaromatic double-bond-containing monomer having at least one kind of functional group selected from the group consisting of carboxyl group, acid anhydride group, epoxy group and isocyanate group or a derivative of the monomer (B2).

### BACKGROUND OF THE INVENTION

1. Technical Field

The present invention relates to a method for producing a modified polyolefin resin. More particularly, the invention relates to a simple method for producing a modified polyolefin resin by which a high graft amount can be achieved.

2. Description of the Related Art

Polypropylene resin has been widely used in various fields and fabricated into various types of molded articles such as automotive interior or exterior materials and components of household electric appliances. Further, materials with improved performance have been developed using polypropylene resin, for example, by blending a different type of polymer to form alloy, or by combining an inorganic material to form a composite material or by laminating metal.

Since polypropylene resin is of poor affinity with other materials, however, unsaturated carboxylic acids or derivatives thereof have been grafted on polypropylene resin in order to improve the affinity with other materials.

For example, Japanese Unexamined Patent publication No. 2002-20436 discloses, as a method for producing a modified polypropylene resin with excellent affinity with other materials, a method for producing a modified polypropylene resin comprising melt kneading a crystalline ultra-high-molecular-weight polypropylene resin having a melting point of from 150 to 170° C. and an intrinsic viscosity of from 5 to 15 dl/g with an ethylenically unsaturated bond-containing monomer and an organic peroxide.

Japanese Unexamined Patent publication No. 2002-308947 discloses, as a method for producing an acid modified polypropylene resin with a high acid graft amount, a method of blending an unsaturated carboxylic acid and/or its derivative and two kinds of organic peroxides differing in decomposition temperature at which the half-life is one minute with a polypropylene resin, followed by melt kneading.

However, in order to develop materials with improved performance, there is a demand for improving the affinity with other materials. Specifically, to increase the content of ethylenically unsaturated bond-containing monomers in a modified polyolefin resin easily and simply, in other words, to increase the graft amount of a modified polyolefin resin, has been demanded. Therefore, the methods for producing a modified polypropylene resin disclosed in the above-cited publications are demanded to be further improved.

### SUMMARY OF THE INVENTION

Under such circumstances, the object of the present invention is to provide a simple method for producing a modified polyolefin resin by which a high graft amount can be achieved.

The present invention is directed to a method for producing a modified polyolefin resin comprising melt-kneading 100 parts by weight of polyolefin resin (A), from 0.1 to 20 parts by weight of at least two kinds of nonaromatic double-bond-containing monomer (B) and from 0.01 to 20 parts by weight of organic peroxide (C), wherein at least one member of the at least two kinds of nonaromatic double-bond-containing monomer (B) is a nonaromatic double-bond-containing monomer having at least one kind of functional group selected from the group consisting of amino group, hydroxyl group and mercapto group or a derivative of the monomer (B1), and other at least one member is a nonaromatic double-bond-containing monomer having at least one kind of functional group selected from the group consisting of carboxyl group, acid anhydride group, epoxy group and isocyanate group or a derivative of the monomer (B2).

By use of the present invention, a modified polyolefin resin with a high graft amount can be obtained by a simple method.

### DETAILED DESCRIPTION OF THE INVENTION

Examples of the polyolefin resin (A) used in the present invention include propylene-based resin, ethylene-based resin and α-olefin-based resins composed mainly of α-olefin having 4 or more, preferably from 4 to 8, carbon atoms. Preferred as the polyolefin resin (A) are propylene-based resin and ethylene-based resin. Propylene-based resin is more preferable. Such polyolefin resin (A) may be used singly or in combination of two or more species thereof.

Examples of the propylene-based resin include propylene hompolymers, propylene-ethylene random copolymers, propylene-α-olefin random copolymers, propylene-ethylene-α-olefin random copolymers, and block copolymers obtained by homopolymerizing propylene and then copolymerizing ethylene and propylene.

The content of ethylene in propylene-ethylene random copolymers, the content of α-olefin in propylene-α-olefin random copolymers, and the combined content of ethylene and α-olefin in propylene-ethylene-α-olefin random copolymers are less than 50 mol % based on the combined content of all the monomers constituting individual copolymers.

The content of ethylene, the content of α-olefin, or the combined content of ethylene and α-olefin is determined by the infrared spectrum method disclosed in “New Edition Macromolecule Analysis Handbook” (The Japan Society for Analytical Chemistry, edited by Polymer Analysis Division, Kinokuniya Co., Ltd. (1995)).

Examples of the ethylene-based resin include ethylene homopolymers, ethylene-propylene random copolymers, ethylene-α-olefin random copolymers and ethylene-propylene-α-olefin random copolymers.

The content of propylene in ethylene-propylene random copolymers, the content of α-olefin in ethylene-α-olefin random copolymers, and the combined content of propylene and α-olefin in ethylene-propylene-α-olefin random copolymers are less than 50 mol % based on the combined content of all the monomers constituting individual copolymers.

Examples of the α-olefin-based resins composed mainly of α-olefin having 4 or more carbon atoms include α-olefin-propylene random copolymers and α-olefin-ethylene random copolymers.

The content of propylene in α-olefin-propylene random copolymers and the content of ethylene in α-olefin-ethylene random copolymers are less than 50 mol % based on the combined content of all the monomers constituting individual copolymers.

Examples of α-olefins having 4 or more carbon atoms to be used in polyolefin resin (A) include 1-butene, 2-methyl-1-propene, 2-methyl-1-butene, 3-methyl-1-butene, 1-hexene, 2-ethyl-1-butene, 2,3-dimethyl-1-butene, 1-pentene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, methyl-1-pentene, ethyl-1-hexene, dimethyl-1-hexene, propyl-1-heptene, methylethyl-1-heptene, trimethyl-1-pentene, propyl-1-pentene, diethyl-1-butene, 1-nonene, 1-decene, 1-undecene and 1-dodecene. α-Olefins having from 4 to 8 carbon atoms, specifically, 1-butene, 1-pentene, 1-hexene and 1-octene are preferred.

The polyolefin resin (A) used in the present invention can be produced by using conventional polymerization catalysts and conventional polymerization methods. Examples of such polymerization methods include solution polymerization, slurry polymerization, bulk polymerization and vapor phase polymerization. Such polymerization methods may be used singly or in combination.

For example, polymerization methods disclosed in “New Polymer Production Process” edited by Yasuji SAEKI, published by Kogyo Chosakai Publishing Co. (1994), Japanese Unexamined Patent Publication Nos. 4-323207 and 61-287917 may be used for the production of the polyolefin resin (A).

The polymerization catalysts for use in the production of the polyolefin resin (A) include multisite catalysts and single-site catalysts. Examples of preferable multisite catalysts include catalysts obtained by use of a solid catalyst component comprising a titanium atom, a magnesium atom and a halogen atom. Examples of preferable single-site catalysts include metallocene catalysts.

The nonaromatic double-bond-containing monomer (B) used in the present invention is a compound having at least one kind of nonaromatic double bond in the molecule and/or a compound having a structure capable of being transformed due to dehydration or the like during the production process of the present invention into a structure having at least one kind of nonaromatic double bond in the molecule. The nonaromatic double-bond-containing monomer (B) is a monomer having no aromatic group in the molecule.

Examples of the nonaromatic double-bond-containing monomer (B) include ethylene, propylene, aforementioned α-olefins, diene compounds such as butadiene, unsaturated carboxylic acids and their derivatives.

The addition amount of nonaromatic double-bond-containing monomer (B) used in the present invention is from 0.1 to 20 parts by weight, and preferably from 0.5 to 10 parts by weight based on 100 parts by weight of the polyolefin resin (A). If the addition amount is too small, the graft amount of the monomer (B) to the polyolefin resin (A) will be reduced. If the addition amount is too large, the amount of unreacted nonaromatic double-bond-containing monomer (B) which will remain in a resulting modified polyolefin resin will increase and, for example, may result in failure to achieve a sufficient adhesion in adhesive applications.

In the present invention, at least two kinds of nonaromatic double-bond-containing monomer (B) are added. Use of a combination of two or more kinds of nonaromatic double-bond-containing monomer (B) makes it possible to achieve a higher graft amount of the monomer (B) to the polyolefin resin (A) in comparison to use of only one kind of nonaromatic double-bond-containing monomer (B).

Regarding the blending amount of the nonaromatic double-bond-containing monomer (B), the amount of each kind of the monomer (B) used is 1 mol % or more, more preferably 5 mol % or more, and even more preferably 10 mol % or more, provided that the amount of all the nonaromatic double-bond-containing monomer (B) used is taken as 100 mol %.

For example, in the production using two kinds of nonaromatic double-bond-containing monomer (B) (species 1 and species 2), the blending ratio of species 1 to species 2 is preferably from 1/99 to 99/1, more preferably from 5/95 to 95/5, and even more preferably from 10/90 to 90/10.

A preferable type of nonaromatic double-bond-containing monomer (B) is a monomer having at least one polar functional group. Examples of such polar functional group include a hydroxyl group, a carboxyl group, an oxazoline group, a nitrile group, an epoxy group, an amino group, groups which have been derived from the foregoing functional groups and are in the form of various kinds of salt, and groups resulting from conversion of the foregoing functional groups into esters, acid amides, acid anhydrides, imides, acid azides or acid halides.

More preferable examples are an amino group, a hydroxyl group, a mercapto group, a carboxyl group, an acid anhydride group, an epoxy group and an isocyanate group, which may be in the form of salt or may be converted into an ester, an acid amide, an imide, an acid azide or an acid halide.

In the present invention, at least one member of the at least two kinds of nonaromatic double-bond-containing monomer (B) is a nonaromatic double-bond-containing monomer having at least one kind of functional group selected from the group consisting of amino group, hydroxyl group and mercapto group or a derivative of the monomer (B1), and other at least one member is a nonaromatic double-bond-containing monomer having at least one kind of functional group selected from the group consisting of carboxyl group, acid anhydride group, epoxy group and isocyanate group or a derivative of the monomer (B2).

In a more preferabe embodiment, at least one member is a nonaromatic double-bond-containing monomer having at least one kind of functional group selected from the group consisting of amino group and hydroxyl group or a derivative of the monomer (B1-1), and other at least one member is a nonaromatic double-bond-containing monomer having at least one kind of functional group selected from the group consisting of carboxyl group and acid anhydride group or a derivative of the monomer (B2-1).

Examples of the derivative of a nonaromatic double-bond-containing monomer include nonaromatic double-bond-containing monomers in which a functional group is in the form of salt, and nonaromatic double-bond-containing monomers in which a functional group has been converted into an ester, an acid amide, an imide, an acid azide or an acid halide.

Examples of the nonaromatic double-bond-containing monomers having an amino group include tertiary amino group-containing (meth)acrylates, tertiary amino group-containing unsaturated imide compounds, tertiary amino group-containing (meth)acrylamides, tertiary amino group-containing aromatic vinyl compounds and quaternary ammonium salt group-containing unsaturated compounds.

The tertiary amino group-containing (meth)acrylates include dimethylaminomethyl (meth)acrylate, dimethylaminoethyl (meth)acrylate, dimethylaminopropyl (meth)acrylate and diethylaminoethyl (meth)acrylate.

The tertiary amino group-containing unsaturated imide compounds include reaction products of vinylmorpholines with amine compounds, reaction products of unsaturated carboxylic acid anhydrides with amine compounds. The vinylmorpholines include 4-vinylmorpholine, 2-methyl-4-vinylmorpholine and 4-allylmorpholine. The unsaturated carboxylic acid anhydrides may be maleic anhydride and itaconic anhydride.

The tertiary amino group-containing (meth)acrylamides include dimethylaminomethyl (meth)acrylamide, dimethylaminoethyl (meth)acrylamide and dimethylaminopropyl (meth)acrylamide.

The quaternary ammonium salt group-containing unsaturated compounds include compounds resulting from cationization of tertiary amino group-containing unsaturated compounds, such as N,N,N-trimethyl-N-(2-hydroxy-3-methacryloyloxypropyl)ammonium chloride with cationizing agents.

The cationizing agents for cationization of tertiary amino group-containing unsaturated compounds for preparing a quaternary ammonium salt group-containing unsaturated compounds include alkyl halide derivatives, alkyl haloacetates, dialkyl sulfates, inorganic acids, organic acids and epihalohydrin adducts of tertiary amine-mineral acid salts.

The alkyl halide derivatives include methyl chloride, ethyl chloride, butyl chloride, octyl chloride, lauryl chloride, stearyl chloride, cyclohexyl chloride, benzyl chloride, phenethyl chloride, allyl chloride, methyl bromide, ethyl bromide, butyl bromide, octyl bromide, lauryl bromide, stearyl bromide, benzyl bromide, allyl bromide, methyl iodide, ethyl iodide, butyl iodide, octyl iodide, lauryl iodide, stearyl iodide and benzyl iodide.

The alkyl haloacetates include methyl monochloroacetate, ethyl monochloroacetate and ethyl bromoacetate. The dialkyl sulfates include dimethyl sulfate and diethyl sulfate. The inorganic acids include hydrochloric acid, hydrobromic acid, sulfuric acid and phosphoric acid. The organic acids include formic acid, acetic acid and propionic acid. The epihalohydrin adducts of tertiary amine-mineral acid salts include N-(3-chloro-2-hydroxypropyl)-N,N,N-trimethylammonium chloride.

Examples of the nonaromatic double-bond-containing monomer having a hydroxyl group include compounds represented by structural formula (1) shown below, unsaturated alcohols, vinyl ethers, allyl ethers and alkenylphenols. 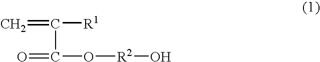
wherein in structural formula (1), R¹ represents a hydrogen atom or an alkyl group having from 1 to 6 carbon atoms and R² represents a methylene group, an alkylene group having from 2 to 20 carbon atoms or a cycloalkylene group having from 3 to 20 carbon atoms.

The compounds represented by structural formula (1) may be (meth)acrylates, examples of which include 2-hydroxymethyl (meth)acrylate, 2-hydroxylethyl (meth)acrylate, 2-hydroxypropyl (meth)acrylate, 2-hydroxybutyl (meth)acrylate, polyethylene glycol mono(meth)acrylate, polypropylene glycol mono(meth)acrylate, poly(ethylene glycol-propylene glycol) mono(meth)acrylate, poly(ethylene glycol-tetramethylene glycol) mono(meth)acrylate, poly(propylene glycol-tetramethylene glycol) mono(meth)acrylate and propylene glycol polybutylene glycol mono(meth)acrylate.

The unsaturated alcohols include allyl alcohol, 9-decen-1-ol, 10-undecen-1-ol and propargyl alcohol. Examples of the vinyl ethers include 2-hydroxyethyl vinyl ether, diethylene glycol monovinyl ether and 4-hydroxybutyl vinyl ether. The allyl ethers include 2-hydroxyethyl allyl ether. The alkenylphenols include p-vinylphenol and 2-propenylphenol.

Examples of the nonaromatic double-bond-containing monomers having a mercapto group include monomers having a structure resulting from substitution of the hydroxyl group of the aforementioned nonaromatic double-bond-containing monomer having a hydroxyl group with an SH group.

The nonaromatic double-bond-containing monomers having a carboxyl group include unsaturated dicarboxylic acids and unsaturated monocarboxylic acids. The unsaturated dicarboxylic acids include maleic acid, fumaric acid, chloromaleic acid, himic acid, citraconic acid and itaconic acid. The unsaturated monocarboxylic acids include acrylic acid, butanoic acid, crotonic acid, vinylacetic acid, methacrylic acid, pentenoic acid, dodecenoic acid, linolic acid, angelic acid and cinnamic acid.

The nonaromatic double-bond-containing monomers having an acid anhydride group include the aforementioned anhydrides of unsaturated dicarboxylic acids or unsaturated monocarboxylic acids, specific examples of which include maleic anhydride, himic anhydride and acrylic anhydride.

The nonaromatic double-bond-containing monomers having an epoxy group include glycidyl (meth)acrylate, (meth)acryl glycidyl ether and allyl glycidyl ether.

The nonaromatic double-bond-containing monomer having an isocyanate group include (meth)acryloyl isocyanate, crotonyl isocyanate, crotonic acid isocyanate ethyl ester, crotonic acid isocyanate butyl ester, crotonic acid isocyanate ethyl ethylene glycol, crotonic acid isocyanate ethyl diethylene glycol, crotonic acid isocyanate ethyl triethylene glycol, (meth)acrylic acid isocyanate ethyl ester, (meth)acrylic acid isocyanate butyl ester, (meth)acrylic acid isocyanate hexyl ester, (meth)acrylic acid isocyanate octyl ester, (meth) acrylic acid isocyanate lauryl ester (meth) acrylic acid isocyanate hexadecyl ester, (meth)acrylic acid isocyanate ethylene glycol, (meth)acrylic acid isocyanate ethyl diethylene glycol and (meth)acrylic acid isocyanate ethyl triethylene glycol.

The organic peroxide (C) used in the present invention may be selected from conventional organic peroxides. Examples of such organic peroxides include diacylperoxide compounds, percarbonate compounds (compounds (I) having a structure represented by the following structural formula (2) in the molecular skeleton) and alkyl perester compounds (compounds (II) having a structure represented by the following structural formula (3) in the molecular skeleton).

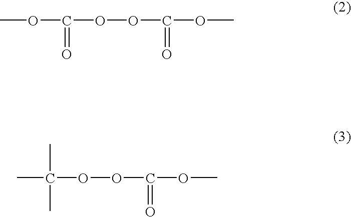

Examples of the compounds (I) represented by structural formula (2) include di-3-methoxybutyl peroxydicarbonate, di-2-ethylhexyl peroxydicarbonate, bis(4-tert-butylcyclohexyl) peroxydicarbonate, diisopropyl peroxydicarbonate, tert-butylperoxyisopropyl carbonate and dimyristyl peroxycarbonate. Examples of the compounds (II) represented by structural formula (3) include 1,1,3,3-tetramethylbutyl neodecanoate, α-cumylperoxy neodecanoate and tert-butylperoxy neodecanoate.

Examples of organic peroxide (C) other than the compounds represented by structural formulas (2) and (3) include 1,1-bis(tert-butylperoxy)cyclohexane, 2,2-bis(4,4-di-tert-butylperoxycyclohexyl)propane, 1,1-bis(tert-butylperoxy)cyclododecane, tert-hexylperoxyisopropyl monocarbonate, tert-butylperoxy-3,5,5-trimethyl haxonoate, tert-butyl peroxylaurate, 2,5-dimethyl-2,5-di(benzoylperoxy)hexane, tert-butyl peroxyacetate, 2,2-bis(tert-butylperoxy)butene, tert-butyl peroxybenzoate, n-butyl 4,4-bis(tert-butylperoxy)valerate, di-tert-butyl peroxyisophthalate, dicumyl peroxide, 2,5-dimethyl-2,5-di(tert-butylperoxy)hexane, 1,3-bis(tert-butylperoxyisopropyl)benzene, tert-butyl cumyl peroxide, di-tert-butyl peroxide, p-menthane hydroperoxide and 2,5-dimethyl-2,5-di(tert-butylperoxy)hexyne-3.

The amount of the organic peroxide (C) to be used is from 0.01 to 20 parts by weight, and preferably from 0.03 to 10 parts by weight based on 100 parts by weight of the polyolefin resin (A). If the addition amount is too small, the graft amount of nonaromatic double-bond-containing monomer (B) to a polyolefin resin will be reduced. If the addition amount is too large, decomposition of the polyolefin resin will be promoted.

The method of melt kneading used in the present invention may be, for example, a conventional method of melt kneading resins or a conventional method of melt kneading resin with solid or liquid additives. A preferable method is a method in which all ingredients or some combinations of ingredients are mixed in a mixer, such as a Henschel mixer and a ribbon blender, to result in a uniform mixture and the mixture is melt-kneaded. The melt-kneading may be conducted by conventional melt kneading techniques such as melt kneading using a Banbury mixer, a plastomill, a Brabender plastograph or a single or twin screw extruder.

Melt-kneading using a single or twin screw extruder is preferred. Because of possibility of improvement in productivity due to continuous production, a method is particularly preferred in which a polypropylene resin (A), at least two kinds of nonaromatic double-bond-containing monomers (B) and an organic peroxide (C) are fully mixed to yield a mixture and then the resulting mixture is fed into and melt-kneaded in a single or twin screw extruder.

The temperature of the kneading portion of the extruder used for melt-kneading (for example, the cylinder temperature of an extruder) is typically from 50 to 300° C. and, from the viewpoints of graft amount and prevention of decomposition of the polyolefin resin, preferably from 100 to 250° C.

It is permitted that the kneading portion of an extruder is divided into two tandem sections and the kneading temperature at the downstream section is set to be higher than that at the upstream section. The kneading time is typically from 0.1 to 30 minutes and, from the viewpoints of graft amount and prevention of decomposition of the polyolefin resin, preferably from 0.5 to 5 minutes.

In the method for producing a modified polyolefin resin of the present invention, conventional additives which are widely added to polyolefin resins, such as antioxidants, heat stabilizers and neutralizers, may also be added, if necessary.

### EXAMPLES

The present invention is described below with reference to examples and comparative examples. The materials shown below were used in the examples and comparative examples.
A-1: Propylene-Based Resin

A propylene homopolymer (intrinsic viscosity [η]: 3 dl/g), prepared by a gas phase polymerization process using the solid catalyst component disclosed in Japanese Unexamined Patent Publication No. 7-216017.
B-1: 2-Hydroxyethyl methacrylate (made by Tokyo Chemical Industry Co. Ltd.)
B-2: Maleic anhydride (made by Nippon Shokubai Co., Ltd.)
B-3: tert-Butyl peroxybenzoate (trade name: KAYABUTYL B, made by Kayaku Akzo Corp.)
B-4: Organic porous powder (trade name: MP-1000, made by MEMABRANA)
B-5: IRGANOX 1010, made by Ciba Specialty Chemicals
B-6: IRGAFOS168, made by Ciba Specialty Chemicals

The evaluation methods used in the examples and comparative examples are shown below.

(1) Graft Amount (Unit: % by Weight)

A sample 1.0 g was dissolved in 100 ml of xylene. The solution of the sample was dropped into 1000 ml of methanol under stirring, and thereby the sample was collected by reprecipitation. The sample collected was vacuum dried (80° C., 8 hours) and shaped into a 100-μm film by heat pressing. The resulting film was measured for infrared absorption spectrum. The maleic anhydride graft amount was determined on the basis of absorption near 1780 cm⁻¹ and the 2-hydroxyethyl methacrylate graft amount was determined on the basis of absorption near 1730 cm⁻¹.

(2) Melt Flow Rate (MFR, Unit: g/10 min)

MFR was measured under the following conditions in accordance with ASTM D792.

Measurement temperature: 230° C.

Load: 21.2 N

### Example 1

Pellets for evaluation were prepared by mixing (A-1), (B-1), (B-2), (B-3), (B-4), (B-5) and (B-6) uniformly at compounding ratios given in Table 1, followed by melt-kneading in a twin screw kneading extruder (trade name: KZW15-45MG, made by Technovel Corp., co-rotating screw, 15 mm×45 L/D) at a temperature of 180° C. and a screw speed of 500 rpm. The graft amount and MFR of the resulting pellets for evaluation were measured and the results are shown in Table 2.

### Example 2

Evaluations were conducted in the same manner as Example 1, except for changing the amounts of (B-1) and (B-2) to those shown in Table 1.

### Comparative Example 1

Evaluations were conducted in the same manner as Example 1, except for failing to using (B-2) and changing the amount of (B-1) to that shown in Table 1.

### Comparative Example 2

Evaluations were conducted in the same manner as Example 1, except for failing to using (B-1) and changing the amount of (B-2) to that shown in Table 1.

TABLE 1

| | | | Comparative | |
|---|---|---|---|---|
| | Example | | Example | |
| | 1 | 2 | 1 | 2 |
| Composition | | | | |
| (A) Propylene-based resin | | | | |
| Species | A-1 | A-1 | A-1 | A-1 |
| Amount (parts by weight) | 100 | 100 | 100 | 100 |
| (B) Compound | | | | |
| Species | B-1 | B-1 | B-1 | — |
| Amount (parts by weight) | 10 | 6 | 12 | — |
| Species | B-2 | B-2 | — | B-2 |
| Amount (parts by weight) | 1.5 | 4.5 | — | 9.1 |
| Species | B-3 | B-3 | B-3 | B-3 |
| Amount (parts by weight) | 2.4 | 2.4 | 2.4 | 2.4 |
| Species | B-4 | B-4 | B-4 | B-4 |
| Amount (parts by weight) | 5.8 | 5.0 | 1.9 | 1.0 |
| Species | B-5 | B-5 | B-5 | B-5 |
| Amount (parts by weight) | 0.2 | 0.2 | 0.2 | 0.2 |
| Species | B-6 | B-6 | B-6 | B-6 |
| Amount (parts by weight) | 0.2 | 0.2 | 0.2 | 0.2 |
| Evaluation result | | | | |
| Graft amount of B-1 (% by weight) | 3.3 | 2.9 | 2.2 | — |
| Graft amount of B-2 (% by weight) | 0.6 | 1.4 | — | 0.4 |
| MFR (g/10 min) | 3.0 | 52 | 240 | 120 |

In Examples 1 and 2, modified propylene-based resin with high graft amounts were successfully produced by a simple method.

On the other hand, in Comparative Examples 1 and 2, use of only one kind of nonaromatic double-bond-containing monomer (B) resulted in unsatisfactory graft amounts.

What is claimed is:

1. A method for producing a modified polyolefin resin comprising melt-kneading 100 parts by weight of polyolefin resin (A), from 0.1 to 20 parts by weight of at least two kinds of nonaromatic double-bond-containing monomer (B) and from 0.01 to 20 parts by weight of organic peroxide (C), wherein at least one member of the at least two kinds of nonaromatic double-bond-containing monomer (B) is a nonaromatic double-bond-containing monomer having at least one kind of functional group selected from the group consisting of amino group, hydroxyl group and mercapto group or a derivative of the monomer (B1), and other at least one member is a nonaromatic double-bond-containing monomer having at least one kind of functional group selected from the group consisting of carboxyl group, acid anhydride group, epoxy group and isocyanate group or a derivative of the monomer (B2).

2. The method for producing a modified polyolefin resin according to claim 1, wherein at least one member among the at least two kinds of nonaromatic double-bond-containing monomer (B) is a nonaromatic double-bond-containing monomer having at least one kind of functional group selected from the group consisting of amino group and hydroxyl group or a derivative of the monomer (B1-1), and other at least one member is a nonaromatic double-bond-containing monomer having at least one kind of functional group selected from the group consisting of carboxyl group and acid anhydride group or a derivative of the monomer (B2-1).
